(19) United States
(12) Patent Application Publication
(10) Pub. No.: US 2009/0129882 A1
(43) Pub. Date: May 21, 2009

(54) Methods, Systems, and Devices for Monitoring Tools in a Dental Milling Machine

(75) Inventors: Andrei Tchouprakov, Plano, TX (US); Roman Sokolov, Richardson, TX (US); Greg Radighieri, Dallas, TX (US)

Correspondence Address: HAYNES AND BOONE, LLP;IP Section, 2323 Victory Avenue, Suite 700, Dallas, TX, 75219, US

(73) Assignee: D4D TECHNOLOGIES, LLC, Richardson, TX (US)

(21) Appl. No.: 12/271,352

(22) Filed: Nov. 14, 2008

Related U.S. Application Data
(60) Provisional application No. 60/988,199, filed on Nov. 15, 2007.

(51) Int. Cl. A61C 19/00; B23Q 11/00

(52) U.S. Cl. 409/131; 433/25

(57) ABSTRACT

Methods, systems, and devices for monitoring tool breakage and wear in a dental milling machine are provided. In one embodiment, a dental milling system includes a milling tool for milling a dental prosthetic and a spindle operable to receive, fixedly engage, and rotate the milling tool. A first accelerometer is positioned adjacent to the spindle and is operable to detect vibrations associated with rotation of the milling tool. A processor is in communication with the first accelerometer to receive data sets representative of the vibrations detected by the first accelerometer. The processor processes the data sets to identify changes in one or more harmonics of the detected vibrations indicative of a break of the milling tool.

### PRIORITY

The present application claims priority to U.S. Provisional Patent Application No. 60/988,199 filed Nov. 15, 2007 and titled “Break Detection of Grinding Tools in a Dental Milling Machine”, which is hereby incorporated by reference in its entirety.

### BACKGROUND

The present disclosure relates to the monitoring of milling tools. In particular, the present disclosure relates to the monitoring of one or more tools of a dental milling machine for indicators of tool breakage and/or tool wear during a milling process.

Dental milling machines are used to mill dental restorations. The milling machines grind or cut away portions of a block of material (e.g., ceramic, gold, porcelain, etc.) in order to create the dental restoration. The milling machines utilize one or more tools to shape the restoration, including cutting tools and/or grinding tools. During the course of the milling process, the tools wear down and/or break because of the high amount of friction and/or loading associated with forming the dental restoration. A tool breakage results in a significant delay in completion of the dental restoration because the milling machine will continue to try to mill the restoration after the breakage, resulting in an improper restoration as the broken tool cannot properly prepare the block. This requires the dental restoration to be completely remilled in the event of damage to the block and, therefore, the restoration caused by the broken tool.

Accordingly, there is a need for improved methods, systems, and devices for monitoring milling tools and, in particular, monitoring tools of a dental milling machine for indicators of tool breakage and/or tool wear.

### SUMMARY

Methods, systems, and devices for monitoring tool breakage and/or wear are provided.

In one embodiment, a dental milling system is provided. The milling system includes a milling tool for milling a dental prosthetic and a spindle operable to receive, fixedly engage, and rotate the milling tool. A first accelerometer is positioned adjacent to the spindle and is operable to detect vibrations associated with rotation of the milling tool. A processor is in communication with the first accelerometer to receive data sets representative of the vibrations detected by the first accelerometer. The processor processes the data sets to identify changes in one or more harmonics of the detected vibrations indicative of a break of the milling tool.

In another embodiment, a method of detecting a tool break in a dental milling machine is provided. The method includes monitoring vibrations associated with rotation of a milling tool in an unloaded state; monitoring vibrations associated with rotation of the milling tool in a loaded state; identifying one or more harmonics associated with rotation of the milling tool in the loaded state; and monitoring vibrations associated with rotation of the milling tool for the one or more identified loaded-state harmonics during a milling process to detect a break of the first milling tool.

In another embodiment, a method of milling a dental prosthetic is provided. The method includes detecting vibrations of a milling machine during a milling process with an accelerometer, where the milling machine comprises a spindle for rotating a tool engaged with the spindle. The method further includes analyzing data sets representative of the detected vibrations for changes in amplitude of one or more harmonics of the tool rotation indicative of tool breakage. In some instances, the method further comprises stopping the milling process upon detection of a change in amplitude indicative of tool breakage, replacing the broken tool with a replacement tool, and resuming the milling process.

Additional aspects, features, and embodiments of the present disclosure are described in the following detailed description.

### BRIEF DESCRIPTION OF THE DRAWINGS

FIG. 1 is a diagrammatic schematic view of a milling system according to one embodiment of the present disclosure.

FIG. 2 is a diagrammatic schematic view of a milling system similar to that of FIG. 1, but illustrating another embodiment of the present disclosure.

FIG. 3 is a diagrammatic schematic view of a milling system similar to that of FIGS. 1 and 2, but illustrating another embodiment of the present disclosure.

FIG. 4 is a flowchart illustrating a method of monitoring tool breakage according to one aspect of the present disclosure.

FIG. 5 is a graph illustrating characteristics of the vibrations of a milling tool in an unloaded state according to one aspect of the present disclosure.

FIG. 6 is a graph illustrating characteristics of the vibrations of a milling tool similar to that of FIG. 5, but illustrating a milling tool in a loaded state according to one aspect of the present disclosure.

FIG. 7 is a graph illustrating the graphs of FIGS. 5 and 6.

FIG. 8 is a diagrammatic perspective view of a milling system according to one embodiment of the present disclosure.

FIG. 9 is a diagrammatic perspective view of a milling subassembly of the milling system of FIG. 8, according to one aspect of the present disclosure.

FIG. 10 is a diagrammatic perspective view of a motor and spindle portion of the milling subassembly of FIG. 9, according to one aspect of the present disclosure.

FIG. 11 is a diagrammatic perspective view of a mandrel subassembly of the milling system of FIG. 8, according to one aspect of the present disclosure.

FIG. 12 is a diagrammatic perspective view of a tool changer of the mandrel subassembly of FIG. 11 adjacent a tool and spindle of the milling subassembly of FIG. 9.

FIG. 13 is a diagrammatic perspective view of the tool changer of FIG. 12 engaging the tool and spindle of the milling subassembly of FIG. 9.

FIG. 14 a flowchart illustrating a method of monitoring for tool breakage during a milling process according to one aspect of the present disclosure.

FIG. 15 a flowchart illustrating a method of monitoring for tool breakage during a milling process having a plurality of tool loading states according to one aspect of the present disclosure.

FIG. 16 a flowchart illustrating a method of monitoring for spindle wear and/or breakage according to one aspect of the present disclosure.

FIG. 17 a flowchart illustrating a method of monitoring for tool wear according to one aspect of the present disclosure.

FIG. 18 a flowchart illustrating a method of monitoring for tool wear during a milling process according to one aspect of the present disclosure.

FIG. 19 a flowchart illustrating a method of monitoring for tool wear and/or breakage during a milling process according to one aspect of the present disclosure.

### DETAILED DESCRIPTION

For the purposes of promoting an understanding of the principles of the present disclosure, reference will now be made to the embodiments, or examples, illustrated in the drawings and specific language will be used to describe the same. It will nevertheless be understood that no limitation of the scope of the present disclosure is thereby intended. Any alterations and further modifications in the described embodiments, and any further applications of the principles as described herein are fully contemplated as would normally occur to one skilled in the art to which the disclosure relates.

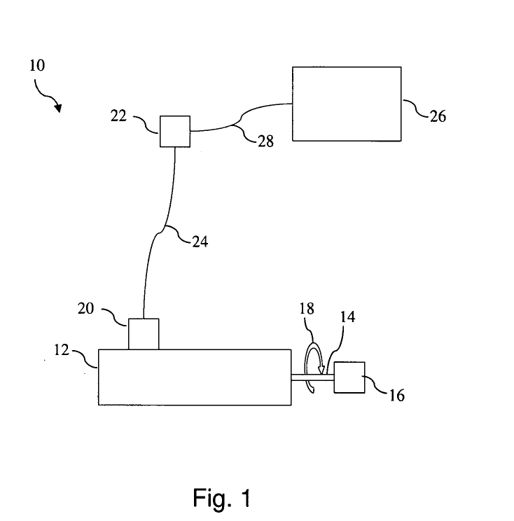

Referring to FIG. 1, shown therein is a diagrammatic schematic view of a milling system 10 according to one embodiment of the present disclosure. In that regard, the milling system 10 includes a spindle 12 that receives and fixedly engages a tool 14 for milling a block 16. In some instances, the spindle 12 includes a motor for providing power to rotate the tool 14 as indicated by arrow 18. In that regard, the rotating tool 14 is utilized to grind, machine, cut, and/or otherwise remove material from the block 16 to shape a dental restoration in some embodiments. Accordingly, the tool 14 is moved with respect to the block 16 and/or the block is moved with respect to the tool to facilitate removal of specific portions and amounts of the block to appropriately shape of the block.

The milling system 10 further includes an accelerometer 20. Generally, the accelerometer 20 is configured for monitoring and detecting vibrations of the milling system 10 and, in particular, vibrations associated with rotation of the milling tool 14 and/or spindle 12. Accordingly, the accelerometer 20 is positioned within the milling system 10 at a location adjacent to the milling tool 14 and/or spindle 12 in some instances. In the illustrated embodiment, the accelerometer 20 is positioned on the housing of the spindle 12. However, in other embodiments the accelerometer is positioned elsewhere adjacent to the milling tool 14 and/or spindle 12. In that regard, the accelerometer 20 is not necessarily in contact with the spindle 12 and is spaced from the spindle and the milling tool 14 in some instances. In some instances, analog accelerometers are utilized. Examples of suitable accelerometers include, without limitation, Analog Devices ADXL322 and Analog Devices ADXL001.

The accelerometer 20 is in communication with an analog-to-digital converter 22. The analog-to-digital converter 22 receives analog signals output by the accelerometer 20 indicative of the detected vibrations and converts the analog signals to corresponding digital signals. In the illustrated embodiment, the accelerometer 20 is shown connected to the analog-to-digital converter 22 via line 24, which may be any type of suitable communication line between the accelerometer and converter. An example of a suitable analog-to-digital convertor is the ARM microcontroller NXP LPC2146, which has two built-in 10 bit ADCs.

The analog-to-digital converter 22 is in communication with a processing system 26. The processing system 26 receives the digital signals output by the analog-to-digital converter 22 and processes the digital signals to detect indicators of tool wear and/or tool breakage. Exemplary processing methods are described in greater detail below. However, in general, the processing system 26 analyzes the digital signals for changes in amplitude of harmonics of the tool rotation speed that are indicative of tool wear and/or tool breakage. In the illustrated embodiment, the processing system 26 is shown connected to the analog-to-digital converter 22 via line 28, which may be any type of suitable communication line between the processing system and converter. In some instances, the processing system 26 controls other aspects of the milling system 10, such as spindle/motor speed, positioning of the spindle 12, positioning of the block 16, and/or other features of the milling system. Accordingly, as described below, in some instances the processing system 26 does not continuously monitor for tool wear and/or tool breakage, but rather intermittently analyzes data from the accelerometer 20 to detect tool wear and/or tool breakage. In such instances, the processing system does not need to be a real time system, but rather simply have available processing time to process the data for detecting tool wear and/or tool breakage. Accordingly, in some instances the system does not require a separate dedicated processor or processing system for the wear/break detection, but rather utilizes a general processor or processing system of the milling system. Accordingly, a processor suitable for running an Operating System, such as the Microsoft Windows XP or Linux, is used in some instances.

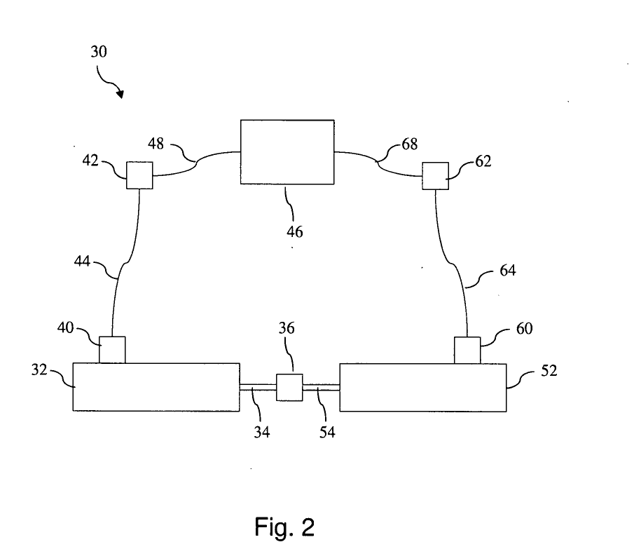

Referring to FIG. 2, shown therein is a diagrammatic schematic view of a milling system 30 according to one embodiment of the present disclosure. The milling system 30 is similar in some aspects to the milling system 10 described above with respect to FIG. 1, however milling system 30 includes multiple tools. In that regard, the milling system 30 includes a spindle 32 that receives and fixedly engages a tool 34 for milling a block 36. In some instances, the spindle 32 includes a motor for providing power to rotate the tool 34. The milling system 30 further includes an accelerometer 40 associated with the spindle 32 and the tool 34. Generally, the accelerometer 40 is configured for monitoring and detecting vibrations of the milling system 30 and, in particular, vibrations associated with rotation of the milling tool 34 and/or spindle 32. Accordingly, the accelerometer 40 is positioned within the milling system 30 at a location adjacent to the milling tool 34 and/or spindle 32 in some instances. In the illustrated embodiment, the accelerometer 40 is positioned on the housing of the spindle 32. The accelerometer 40 is in communication with an analog-to-digital converter 42. The analog-to-digital converter 42 receives analog signals output by the accelerometer 40 indicative of the detected vibrations and converts the analog signals to corresponding digital signals. The accelerometer 40 is shown connected to the analog-to-digital converter 42 via line 44, which may be any type of suitable communication line between the accelerometer and converter.

The analog-to-digital converter 42 is in communication with a processing system 46. The processing system 46 receives the digital signals output by the analog-to-digital converter 42 and processes the digital signals to detect indicators of tool wear and/or tool breakage. In some instances, the processing system 46 analyzes the digital signals for changes in amplitude of harmonics of the tool rotation speed that are indicative of tool wear and/or tool breakage. In the illustrated embodiment, the processing system 46 is shown connected to the analog-to-digital converter 42 via line 48, which may be any type of suitable communication line between the processing system and converter.

The milling system 30 also includes a spindle 52 that receives and fixedly engages a tool 54 for milling block 36 in combination with tool 34. The spindle 52 and the tool 54 are substantially similar to the spindle 32 and the tool 34 in some instances. In that regard, in some instances, the spindle 52 includes a motor for providing power to rotate the tool 54. The rotating tools 34 and 54 are utilized to grind, machine, cut, and/or otherwise remove material from the block 36 to shape a dental restoration in some embodiments. Accordingly, the tools 34 and 54 are moved with respect to the block 36 and/or the block is moved with respect to the tools to facilitate removal of specific portions and amounts of the block to appropriately shape of the block into the desired dental restoration. In some instances, the processing system 46 controls or directs movement of one or more of the spindle 32, tool 34, spindle 52, spindle 54, and block 36.

The milling system 30 further includes an accelerometer 60 associated with the spindle 52 and the tool 54. Generally, the accelerometer 60 is configured for monitoring and detecting vibrations of the milling system 30 and, in particular, vibrations associated with rotation of the milling tool 54 and/or spindle 52. Accordingly, the accelerometer 60 is positioned within the milling system 30 at a location adjacent to the milling tool 54 and/or spindle 52 in some instances. In the illustrated embodiment, the accelerometer 60 is positioned on the housing of the spindle 52. The accelerometer 60 is in communication with an analog-to-digital converter 62. The analog-to-digital converter 62 receives analog signals output by the accelerometer 60 indicative of the detected vibrations and converts the analog signals to corresponding digital signals. The accelerometer 60 is shown connected to the analog-to-digital converter 62 via line 64, which may be any type of suitable communication line between the accelerometer and converter.

The analog-to-digital converter 62 is also in communication with the processing system 46. The processing system 46 receives the digital signals output by the analog-to-digital converter 62 and processes the digital signals to detect indicators of tool wear and/or tool breakage. In that regard, the processing system 46 analyzes the data from the accelerometers 40 and 60 separately in some instances, such that the data associated with accelerometer 40 is indicative of tool wear or breakage of tool 34 and the data associated with accelerometer 60 is indicative of tool wear or breakage of tool 54. In other instances, the processing system 46 analyzes the collective data from both accelerometers 40 and 60 to detect indicators of tool wear and/or tool breakage. In that regard, in some instances, the processing system 46 analyzes the digital signals for changes in amplitude of harmonics of the tool rotation speed that are indicative of tool wear and/or tool breakage. In some such instances, harmonics are associated with the tools 34 and 54 such that changes in amplitude of a particular harmonic is indicative of tool wear or tool breakage of one of the tools 34 or 54. In the illustrated embodiment, the processing system 46 is shown connected to the analog-to-digital converter 62 via line 68, which may be any type of suitable communication line between the processing system and converter.

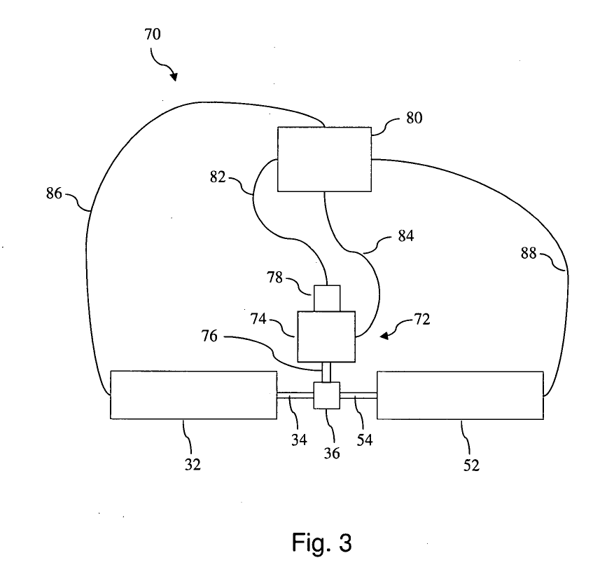

Referring to FIG. 3, shown therein is a diagrammatic schematic view of a milling system 70 according to one embodiment of the present disclosure. The milling system 70 is similar in some aspects to the milling systems 10 and 30 described above with respect to FIGS. 1 and 2, accordingly the same reference numerals are utilized for some components of the system 70. However, no limitation of these components based on the aspects of the previously described milling systems 10 and 30 is intended by this common use of reference numerals. In that regard, the milling system 70 is shown having spindles 32, 52 and tools 34, 54 for milling block 36 similar to milling system 30. However, in the milling system 70 illustrates a mandrel subassembly 72 having a mandrel socket 74 receiving a mandrel 76. The mandrel 76 is fixedly secured to the mandrel socket 74 in some instances. The block 36, in turn, is fixedly secured to the mandrel 76. In some instances, the mandrel socket 74, the mandrel 76, and/or the block 36 include one or more engagement features that ensure a proper and known alignment or orientation between the mandrel socket, the mandrel, and the block.

The milling system 70 further includes an accelerometer 78. Generally, the accelerometer 78 is configured for monitoring and detecting vibrations of the milling system 70 and, in particular, vibrations associated with rotation of the milling tools 34, 54 and/or spindles 32, 52. Accordingly, the accelerometer 78 is positioned within the milling system 70 at a location adjacent to the milling tools 34, 54, spindles 32, 52, and/or mandrel subassembly 72 in some instances. In the illustrated embodiment, the accelerometer 78 is positioned on the mandrel socket 74 of the mandrel subassembly 72. However, in other embodiments the accelerometer is positioned elsewhere adjacent to the milling tools 34, 54, spindles 32, 52, and/or mandrel subassembly 72.

The accelerometer 78 is in communication with a processing system 80. The processing system 80 receives signals output by the accelerometer representative of the detected vibrations. In some instances, the signals output by the accelerometer 78 are digital. In other instances, the signals output by the accelerometer 78 are analog. In some instances, the analog signals output by the accelerometer 78 are passed through an analog-to-digital converter (not shown), which then sends a digital signal representative of the detected vibrations to the processing system 80. The processing system 80 processes the signals received from the accelerometer to detect indicators of tool wear and/or tool breakage. In some instances, the processing system 80 analyzes the signals for changes in amplitude of harmonics of the tool rotation speeds that are indicative of tool wear and/or tool breakage. In some such instances, harmonics are associated with the tools 34 and 54 such that changes in amplitude of a particular harmonic is indicative of tool wear or tool breakage of one of the tools 34 or 54. In the illustrated embodiment, the processing system 80 is shown connected to the accelerometer 78 via line 82, which may be any type of suitable communication line between the processing system and accelerometer.

In some embodiments, the processing system 80 controls other aspects of the milling system 10, such as spindle/motor speed, positioning of the spindles 32, 52, positioning of the block 36, and/or other features of the milling system. Accordingly, in some instances the processing system 80 is in communication with spindles 32, 52 and/or the mandrel subassembly 72. In the illustrated embodiment, the processing system 80 is in communication with the mandrel subassembly 72 via line 84, which may be any type of suitable communication line. In some instances, the processing system 80 provides instructions to the mandrel subassembly 72 regarding positioning of the block 36. In that regard, the mandrel subassembly 72 controls the position of the block 36 in one or more axes in some instances. In one particular embodiment, the mandrel subassembly 72 controls the position of the block 36 in two substantially perpendicular axes defining a plane. The processing system is also shown in communication with the spindle 32 and the spindle 52 via lines 86 and 88, respectively. The lines 86, 88 are any type of suitable communication line for sending signals between the processing system 80 and the spindles 32, 52. In some instances, the processing system 80 provides instructions to the spindles 32, 52 (or devices controlling the spindles) regarding positioning of the tools 34, 54, respectively. In that regard, the spindles 32, 52 control the position of the tools 34, 54, in one or more axes in some instances. In one particular embodiment, the spindles 32, 52 control the position of the tools 34, 54 along an axis substantially perpendicular to the plane of movement of the block 36 as controlled by the mandrel subassembly 72. In some instances, the tools 34, 54 extend substantially parallel to one another, but offset with respect to one another.

Accordingly, in some instances the processing system 80 does not continuously monitor for tool wear and/or tool breakage, but rather intermittently analyzes data from the accelerometer 78 to detect tool wear and/or tool breakage. In some instances, the processing system 80 processes the data as processing time becomes available. In that regard, in some instances one or more processes of the processing system are prioritized such that the highest priority process that is still outstanding is performed first. In some instances, the monitoring of tool wear and/or tool breakage has a lower priority than executing milling commands, such as positioning of the tools 34, 54 and/or block 36, rotation speed of the tools 34, 54, and/or other milling commands. In other instances, the processing system 80 includes a timing circuit for controlling when the data from the accelerometer 78 is analyzed. In some instances, the data is analyzed at a fixed interval. In some instances, the data is analyzed between approximately 4 and 10 times per second, or approximately once every 100 to 300 milliseconds. In other instances, the data is analyzed between approximately 1 and 100 times per second, or once every 1000 to 10 milliseconds. The data is analyzed more or less frequently in other instances. In some instances, the processing system includes memory for storing the data from the accelerometer, the analysis of the data output by the processing system, and/or other information. In that regard, in some instances a series of data points are analyzed and compared to one another to detect tool wear and/or tool breakage. In some instances, use of the series of data points reduces or eliminates the number of false positives of tool wear or tool breakage generated by the system 70.

In some instances, the milling systems and methods of the present disclosure are utilized with the milling systems and/or methods disclosed in U.S. Pat. No. 7,270,592 filed Feb. 22, 2005 and titled “Milling Machine,” hereby incorporated by reference in its entirety. Further, in some instances the milling systems and methods of the present disclosure are utilized in combination with the laser-based systems and methods of optical scanning described in U.S. Pat. No. 7,142,312 filed Dec. 30, 2003 and titled “Laser Digitizer System for Dental Applications,” U.S. Pat. No. 7,184,150 filed Mar. 19, 2004 and titled “Laser Digitizer System for Dental Applications,” U.S. Pat. No. 7,355,721 filed May 5, 2004 and titled “Optical Coherence Tomography Imaging,” and U.S. Pat. No. 7,342,668 filed Sep. 17, 2004 and titled “High Speed Multiple Line Three-Dimensional Digitalization,” each of which is hereby incorporated by reference in its entirety,

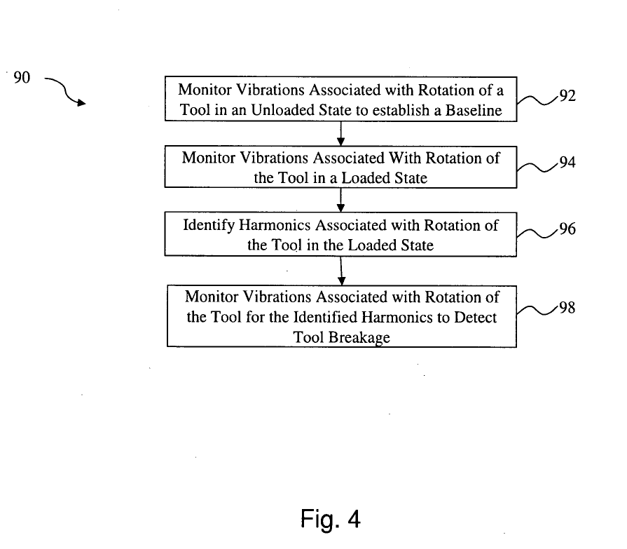

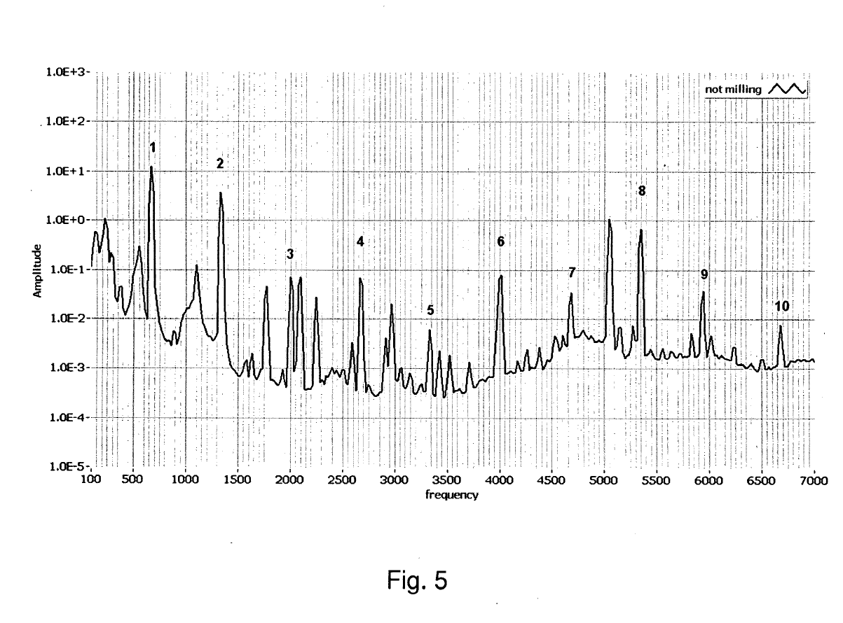

Referring to FIG. 4, shown therein is a flowchart illustrating a method 90 of monitoring tool breakage according to one aspect of the present disclosure. The method 90 begins at step 92 where vibrations associated with rotation of a milling tool in an unloaded state are monitored to establish a baseline. In that regard, in some instances the milling tool is considered to be rotating in an unloaded state when it is freely spinning and not engaged with a milling block. In other words, the only resistance to the tool is caused by the milling system itself and not friction or resistance caused by engaging the tool with a block or other work piece. Referring to FIG. 5, shown therein is a graph illustrating characteristics of the vibrations of the milling tool in an unloaded state according to one embodiment of the present disclosure. In that regard, the graph of FIG. 5 shows an exemplary amplitude spectrum between 0 Hz and 7000 Hz for a milling tool rotated in an unloaded state at a speed of approximately 667 Hz. The first ten harmonics of the milling tool rotation speed in the unloaded state are identified. The amplitudes of these harmonics are considered as the baseline for the tool in the unloaded state at the specific rotation speed. In some instances, the amplitude spectrum is obtained for a plurality of rotation speeds. Generally, the rotation speeds considered are those that will be used in the milling process. In some instances, the rotation speeds are between about 10,000 RPM and 300,000 RPM. In other instances, the rotation speeds are between about 40,000 RPM and 100,000 RPM. However, in some instances rotation speeds other than those utilized in the milling process are utilized to establish a baseline.

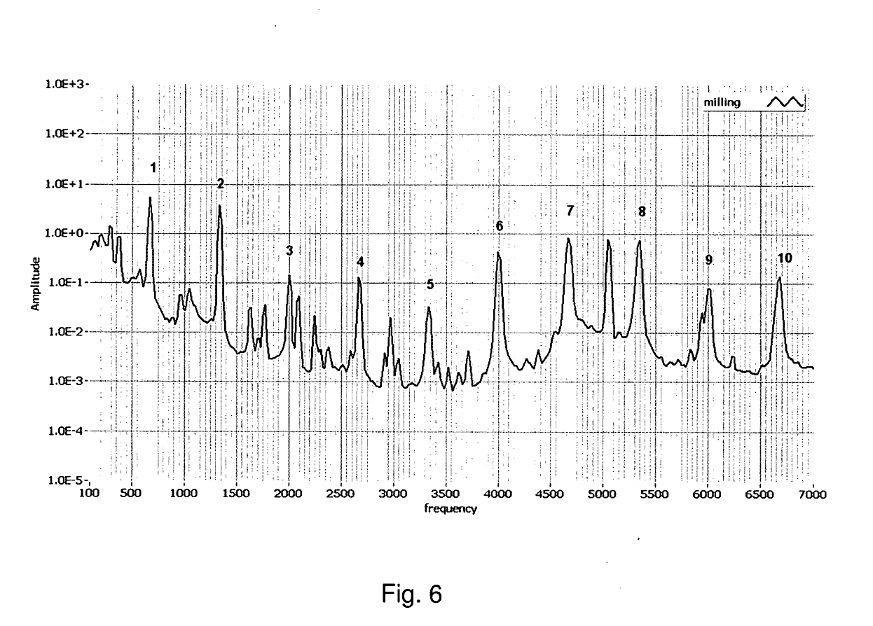

Referring again to FIG. 4, the method 90 continues at step 94 where vibrations associated with rotation of the milling tool in a loaded state are monitored. In that regard, in some instances the milling tool is considered to be rotating in a loaded state when it is subjected to external resistance or friction, such as that caused by engaging a milling block. In other words, the tool is loaded if it is subjected to a load outside of the inherent loads present in the milling system itself. Referring to FIG. 6, shown therein is a graph illustrating characteristics of the vibrations of the milling tool in a loaded state according to one embodiment of the present disclosure. In that regard, the graph of FIG. 6 shows an exemplary amplitude spectrum between 0 Hz and 7000 Hz for a milling tool rotated in a loaded state at a speed of approximately 667 Hz. The first ten harmonics of the milling tool rotation speed in the unloaded state are identified. The amplitudes of these harmonics are considered as the baseline for the tool in the loaded state at the specific rotation speed.

Similar to the unloaded state, in some instances, the amplitude spectrum is obtained for a plurality of rotation speeds. Generally, the rotation speeds considered are those that will be used in the milling process. Further, in some instances, the tool is subjected to different types of loading during the milling process. For example, the loading is dependent on such factors as the tool rotation speed, tool path parameters (e.g., feed rate, depth of cut, stepover, etc.), the type of material being milled (e.g., ceramic, composite, zirconia, gold, etc.), tool type (e.g., cutter, grinder), tool shapes (e.g., profile, number of cutting flutes for cutters, grit size of diamonds for grinders, etc.) and/or other factors. Accordingly, in some instances the amplitude spectrum is obtained for a plurality of loading situations based on one or more of these variables.

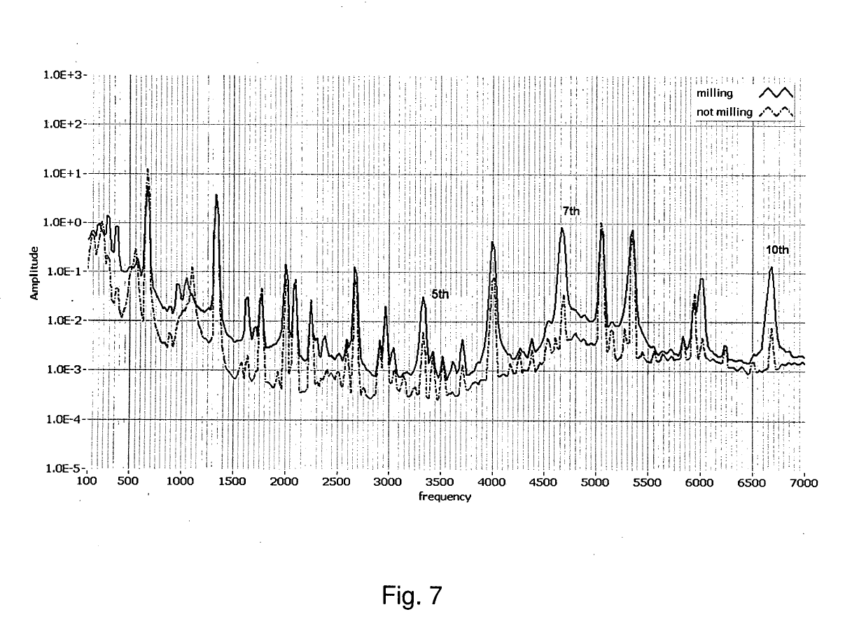

Referring again to FIG. 4, the method 90 continues at step 96 where the harmonics associated with rotation of the tool in the loaded state are identified. Specifically, in some instances the harmonics having a sufficient amplitude difference between the unloaded and loaded states are identified as harmonics associated with rotation of the tool in the loaded state. In that regard, the amount of amplitude difference that is considered to be sufficient is dependent on such factors as the noise in the system, the sensitivity and/or accuracy of the accelerometer, the available processing power of the processing system, the amount of available memory, and/or other factors. Referring to FIG. 7, shown therein is a comparison of the graphs of the milling tool in the unloaded and loaded states of FIGS. 5 and 6. As shown, at least the 5^{th}, 7^{th}, and 10^{th} harmonics have sufficient amplitude differences between the loaded and unloaded states that they are considered to be associated with rotation of the tool in the loaded state. In other instances, other harmonics have sufficient amplitude differences to be associated with rotation of the tool in the loaded state.

Referring again to FIG. 4, the method 90 continues at step 98 where vibrations associated with rotation of the tool are monitored for the harmonics identified at step 96 to detect tool breakage. For example, in some instances the harmonics associated with the rotation of the tool in the loaded state are monitored when the tool is supposed to be in a loaded state in accordance with the planned milling pattern. In some instances, the accelerometer monitors the vibrations of the system only when the tool is to be milling or in a loaded state. In other instances, the accelerometer constantly monitors the vibrations of the system during the milling process, but the processing system only analyzes those vibrations that occur during the time periods when loading of the tool is expected (e.g., during times of cutting and/or grinding of the block). In yet other instances, the accelerometer constantly monitors the vibrations of the system during the milling process and the processing system analyzes all of those vibrations in comparison to the anticipated or expected state of the tool (i.e., loaded or unloaded) at the time of the vibrations were detected.

Generally, if the amplitude of one or more of the identified harmonics varies from the established threshold for the corresponding state of the tool, then it is an indication of tool breakage. For example, in some instances the amplitude of one or more of the identified harmonics is less than the amplitude associated with the loaded state and approaches the baseline amplitude associated with the unloaded state, which is indicative of tool breakage. In some instances, the reduced harmonics are a result of the fact that the broken tool does not engage the block (or only partially engages the block) when an unbroken tool would engage the block. Accordingly, when the increased amplitude of the harmonics associated with the loaded state are not detected it is an indicator that the tool is broken.

Unlike many previous systems and methods for monitoring tool breakage, the method 90 does not require continuous monitoring of the vibrations for tool breakage. Rather, in some instances the vibrations are monitored intermittently. For example, in some instances, the processing unit controlling the milling machine and/or analyzing the data received from the accelerometer requests a sample of vibration data. The vibration data measured by the accelerometer is collected and stored in a data set. In some instances, the data set includes 2048 measured values. In other instances, the data set includes greater or fewer values. In some instances, the size of the data set is dependent on the available memory of the system and/or the available processing power of the system. The vibration data set is stored in a buffer or other memory device for retrieval by the processing unit. In some instances, the buffer or memory device is associated with the processing system. The processing system in turn analyzes the vibration data set to detect variations in the amplitudes of the harmonics indicative of tool breakage. In some instances, the processing system requests the next sample of vibration data upon the completion of the analysis of the previous data set.

Generally, the rate of data sampling is chosen such that a break of the tool is identified within 5 seconds or less after the break occurs. In some instances, the rate of data sampling is selected to be a multiple of the frequency of tool rotation in order to minimize effects of spectral leakage. In some instances, the data sets are collected and analyzed between approximately 4 and 10 times per second, or approximately once every 100 to 300 milliseconds. In other instances, the data is analyzed between approximately 1 and 100 times per second, or once every 1000 to 10 milliseconds. In one particular embodiment, the data sets are collected and analyzed approximately every 200 milliseconds. The exact timing of the data collected is checked against the stored toolpath data in order to determine the corresponding stage (e.g., loaded or unloaded) of the milling process at the time of data collection. In some instances, the stage of the milling process determines what threshold the amplitudes of the harmonics of the data sets are compared against or whether the data set should even be considered. For example, in some instances the data sets associated with non-loaded stages of the milling process are not analyzed.

In some instances, the data sets obtained from the accelerometer are processed in the following manner. First, the data sets are zero-leveled and normalized. Second, a Kaiser window is applied to reduce spectral leakage. In some instances, the Kaiser window has a beta of 7. Next a Fourier transform is performed in order to obtain a power spectrum associated with the data set. A median filter is applied to the power spectrum, and the resulting data are smoothed with a gaussian window having a width equivalent to that of the median filter. In some instances, the median filter and gaussian window have a width of 25. The smoothed power spectrum reduces the effects of the noise present in the signal, while the contributions of harmonic vibrations are excluded by the median filtering. The difference between the log of the original spectrum and the log of smoothed power spectrum is computed and the variance of this quantity is computed over the range of the relevant frequencies. Accordingly, the amplitudes of the identified harmonics are obtained from the power spectrum and normalized according to the formula: An=(Log(A)−Log(N))/Var. Whenever this value exceeds a specified threshold, the corresponding harmonic is deemed to be present in the vibrations. In some instances, the thresholds for each harmonic are determined based on the initial testing of the milling machine where the vibrations associated with the unloaded tool are monitored.

In some instances, the data set is given a binary score for each of the harmonics associated with rotation of the tool in a loaded state. If the harmonic is determined to be present, then a variable associated with the state of the tool for that harmonic is given the value of 1, otherwise the variable is given a value of 0. In some instances, each of the harmonics is monitored such that the lack of presence of a single harmonic is an indicator of tool breakage. In some instances, the sum of the variable values for all of the identified harmonics provides an overall variable score, S. In some instances, a change in the overall variable score, S, during similar milling states (e.g., loaded states) is an indicator of tool breakage. In some instances, a running average of the variable score S and/or each of the harmonics is performed over the successive data sets. Averaging over multiple data sets reduces the possibility of a false positives and false negatives. In some instances, between 10 and 20 successive data sets are utilized for detecting changes indicative of a tool break. Depending on the sample rate of the data sets, the time delay between the actual tool break and detection by the system is between 1-5 seconds and, in some instances, less than 1 second. Further, if the data set was collected during the idle or layering stage of the milling process (i.e., non-loaded stage), then the tool state variable is not included in the running average and is discarded in some instances.

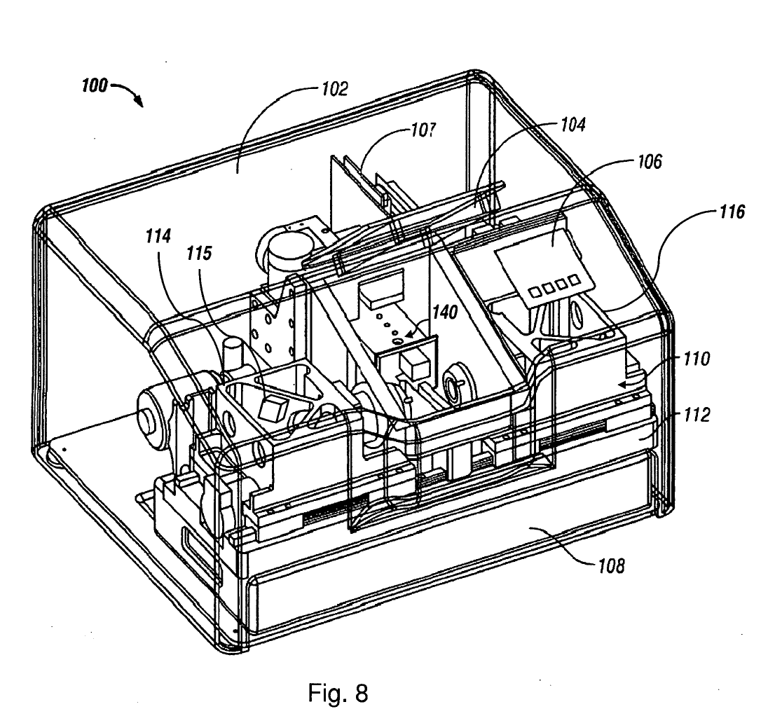

Referring to FIG. 8, shown therein is a diagrammatic perspective view of a milling system 100 according to one embodiment of the present disclosure. The milling system 100 includes a cover 102 that protects the operator from the moving parts within the system. A blank (not shown in FIG. 8) is held within a work area that is accessible through door 104. The milling subassembly 110 is used to move the tools back and forth into engagement with the blank. The milling subassembly 110 includes a first frame 114 and a second frame 116 that slide on rails of a subframe 112. An accelerometer 115 is positioned on the first frame 114 for monitoring vibrations associated with at least one of the tools. A mandrel subassembly 140 is used to control the y-axis and z-axis movement of the mandrel and blank. While the tools are described as being manipulated in the x-axis, this is just an issue of reference. The tools could be manipulated in the y-axis and the blank moved in the x-axis and z-axis. Alternatively, the tools could be manipulated in the z-axis and the blank manipulated in the x-axis and y-axis. A reservoir 108 is also located at the bottom of the machine 100. At least some of the electronics of the system 100 are located in a compartment 107. In some instances, the electronics are controlled by and/or activity of the milling system 100 is displayed on display 106. In some instances, the system 100 includes one or more indicators for indicating a status of the milling process. For example, in some embodiments the system includes a plurality of colored lights, where the colored lights are associated with a status of the milling process. In that regard, in one aspect of the present disclosure a colored light is utilized to indicate a tool break and/or tool change status of the milling system.

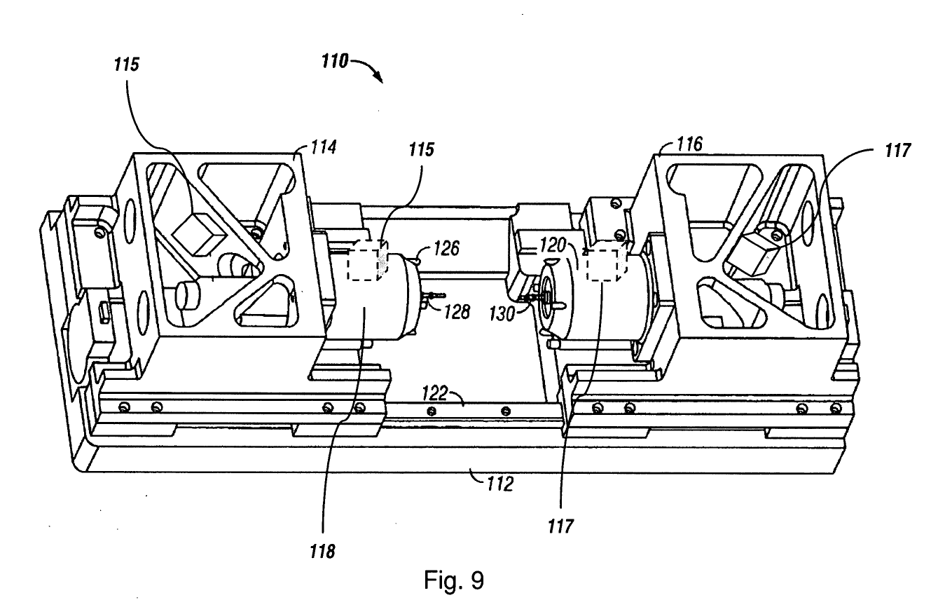

Referring to FIG. 9, shown therein is a diagrammatic perspective view of the milling subassembly 110 of the milling system 100. The milling subassembly includes a first frame 114 and a second frame 116. In one embodiment, these frames are formed from a single block of metal, having no seams to decrease their stiffness. First and second spindles 118, 120 are coupled to these frames 114, 116. In the illustrated embodiment, the frames 114, 116 are moveable along on a single pair of rails 122 to ensure absolute alignment between the frames. In the illustrated embodiment, the central axes of the spindles 118, 120 are aligned. However, in other embodiments the central axes of the spindles 118, 120 are offset. Tools 128 and 130 are accepted into the spindles 118, 120, respectively, along the central axis. The spindles 118, 120 rotate the tools 128, 130 so that a cutting surface on the tool can carve away material from the blank as desired. Generally, motors are used to supply the power to move the frames along the rails and to rotate the tools within the spindles. As shown, each of the frames 114, 116 includes an accelerometer 115, 117, respectively, for monitoring vibrations associated with rotation of the corresponding spindle 118, 120 and tool 128, 130. Alternative positions for the accelerometers 115, 117 are shown in phantom on the spindles 118, 120. In general, the accelerometers 115, 117 are positioned near the spindles 118, 120 and/or tools 128, 130 such that the accelerometers can monitor vibrations associated with rotation of the spindles and tools. However, the accelerometers 115, 117 may be positioned in such a suitable location that does not interfere with the other operations of the milling system 100.

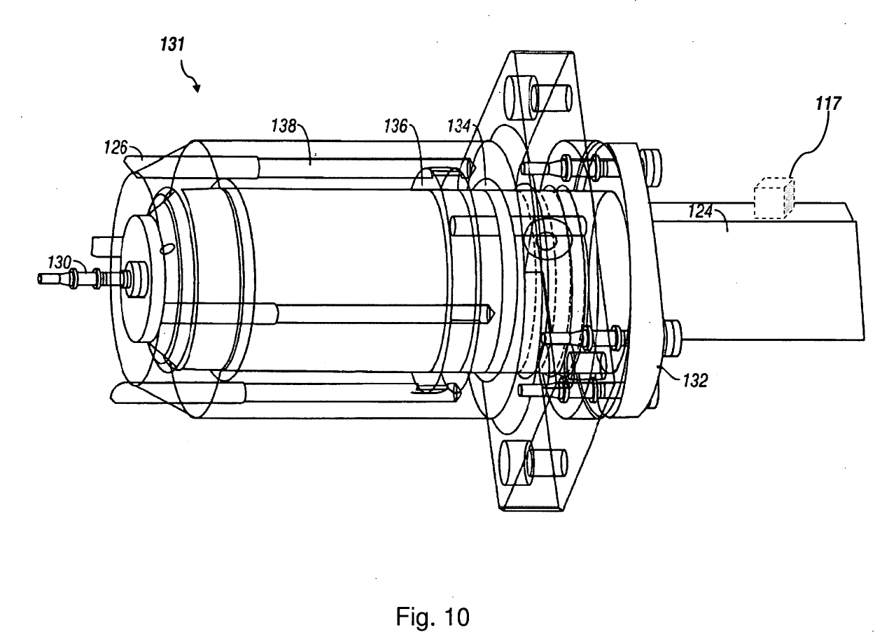

In some embodiments, a fluid stream emits from the spindle ports 126 to wash and/or cool the blank and tools 128, 130 during the milling process. This effluent exits to the reservoir 108 where particulate matter can settle. For example, referring to FIG. 10, shown therein is a diagrammatic perspective view of a motor and spindle portion 131 of the milling subassembly 110. Water, or other cooling fluid, is fed into the spindle through supply 124. Water passes through passages 132 into a collar 136. This collar supplies the water into several tubes 138 that carry the water to the front of the spindle. The water is sprayed from the tips 126 of the tubes 138 and directed toward the tip of the tool 130. In some instances, at least one o-ring is used to seal and separate the spindle's motor from the water. FIG. 10 also illustrates another alternative position for the accelerometer 117, as shown in phantom.

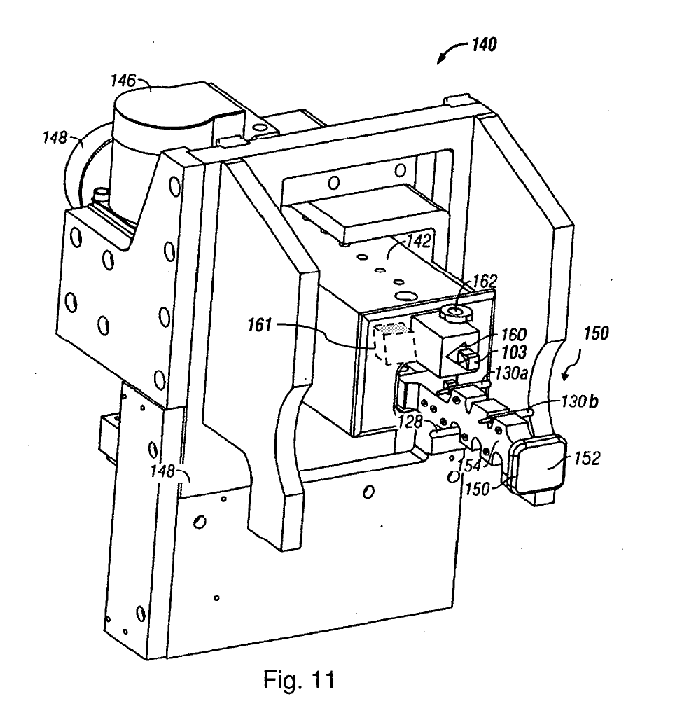

Accurate milling requires knowledge of the exact location of the tips of the tools and the x, y, z coordinates of the blank. Accordingly, very precise motors are used to move the frames 114 and 116 of the milling subassembly 110 to adjust the positions of the tools 128, 130 along the x-axis relative to the blank. Referring to FIG. 11, shown therein is a diagrammatic perspective view of the mandrel subassembly 140 of the milling system 100. The mandrel subassembly 140 precisely controls the y-axis and z-axis coordinates of the block. In that regard, the y-axis is controlled by moving a carriage along rails. A separate z-axis carriage 142 includes the frame for engaging the mandrel 160 and an automatic tool changer 150. This view also illustrates the location of the mandrel 160 and blank 103 to be milled. A cam 162 is used to secure the mandrel 160 in place. The automatic tool changer 150 is also attached to the z-axis carriage. The tool changer can carry several additional tools 128, 130a, and 130b for placement into the spindles 118, 120. The tool changer 150 also includes at least one open port 154 for accepting the tools 128, 130 currently in the spindles 118, 120. An electronics package 152 is located on the end of the tool changer 150.

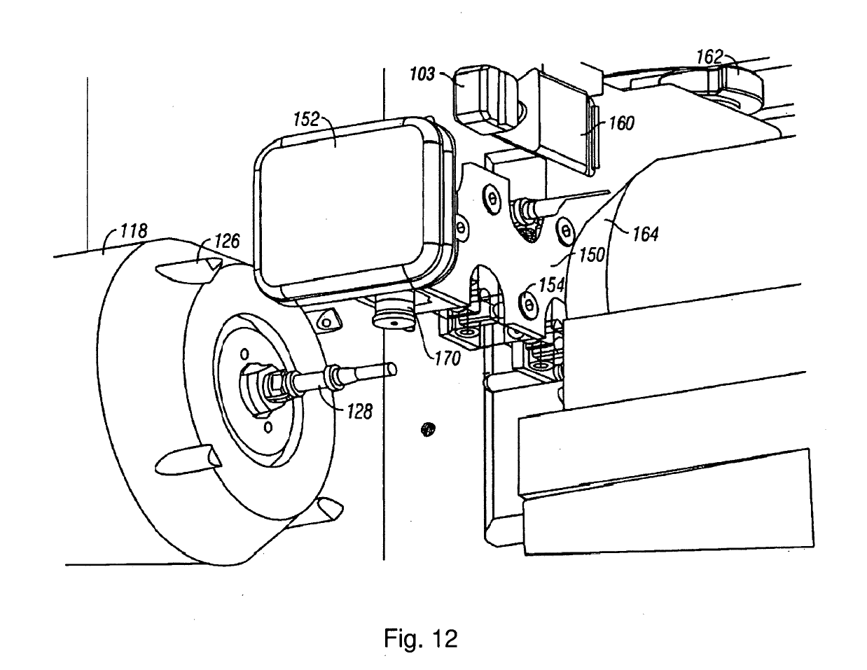

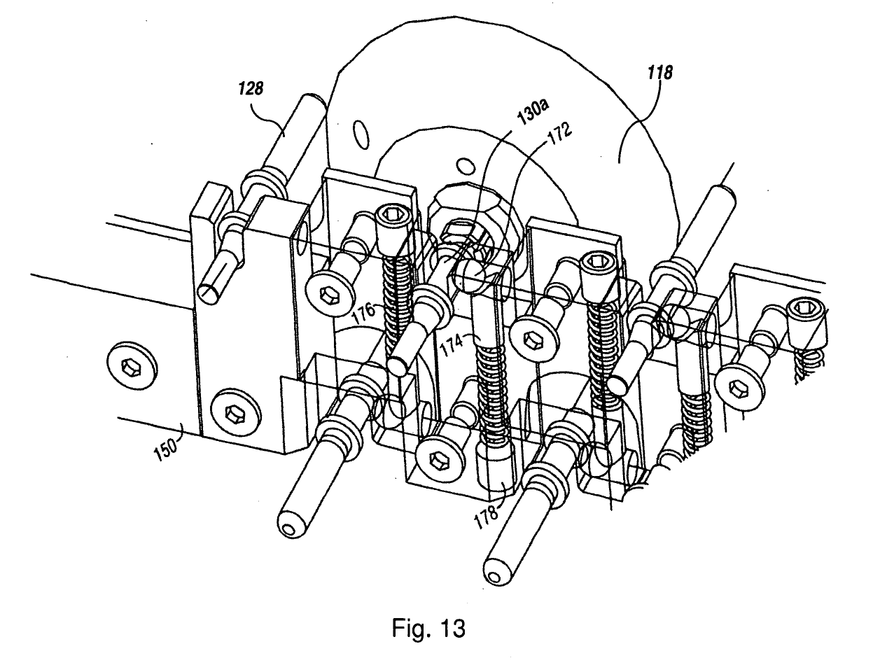

Referring to FIGS. 12 and 13, shown therein is a tool changer 150 of the mandrel subassembly 140. In particular, FIG. 12 is a diagrammatic perspective view of the tool changer 150 adjacent to the tool 128 and spindle 118 of the milling subassembly 110, and FIG. 13 is a diagrammatic perspective view of the tool changer 150 engaging the tool 128 and spindle 118 of the milling subassembly 110. Referring more particularly to FIG. 12, in this view the y-axis carriage has moved the blank 103 above the tool 128. In this position, a sensor 170 of the electronics package 152 is used to inspect the condition of the tip of tool 128. In some instances, the sensor 170 is a camera. In another embodiment, a camera is not used. Instead the tool is positioned in a slot on the tool changer where its position is detected, and its shape and size is calculated. For example, in one particular embodiment, the tool is moved into the slot and past the sensor to detect an upper edge of the tool, then the tool is moved and its lower edge is detected, allowing calculation of the tool's diameter, then the tool is moved and the tip of the tool is detected. This method allows the general measurements of the tool to be determined. Based on these measurements a determination of whether the tool is broken can be made. Accordingly, in some instances, the sensor 170 is utilized to verify a break of a tool indicated by the vibrations associated with the milling process.

Where the tool break is confirmed, or in situations where no confirmation is performed, the broken tool is replaced with a substitute tool by the automatic tool changer 150. The ability to engage and disengage the tools is shown in FIG. 13. The tool changer 150 is positioned with the y-axis carriage to a position in between the spindles 118 and 120 (not shown). Broken tool 128 has been disengaged from the spindle 118 and placed in an open tool holding slot of the automatic tool changer. The selected replacement tool 130a is positioned in co-axial relationship with the central axis of the spindle 118 using the z-axis carriage. A collet on the spindle 118 is opened to engage a distal end of the tool 130a. The tool 130a is releasably secured in the tool changer 150 with a spring loaded ball 172 or other means for securing the tool. Ball 172 presses against a central portion of the tool 130a between a first and second flange. When the tool 130a is engaged in the spindle 118, its collet closes. The tool changer 150 is then lowered with the y-axis carriage. This forces the ball 172 against pin 174 and compressed spring 176. The force on spring 176 can be adjusted using the set screw 178. In this manner, a broken tool can be automatically replaced upon detection by the system without requiring a user to intervene.

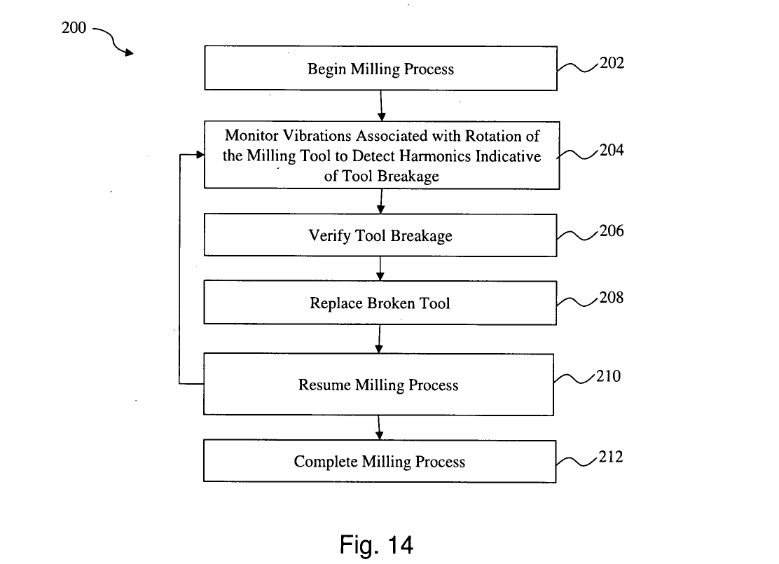

Referring now to FIG. 14, shown therein is a flowchart illustrating a method 200 of monitoring tool breakage during a milling process, according to one aspect of the present disclosure. The method 200 begins at step 202 where a milling process begins. In some instances, the milling process is the milling of a dental prosthetic from a block of suitable dental material. The method 200 continues at step 204 where vibrations associated with rotation of a milling tool are monitored to detect harmonics indicative of tool breakage. In some instances, the harmonics indicative of tool breakage are determined as set forth in method 90 above. In that regard, in some instances step 204 includes identifying the harmonics associated with a loaded tool by comparing the spectrum of a loaded tool to an unloaded tool. In some instances, the harmonics indicative of tool breakage are dependent on the particular type of loading that occurs during the milling process. For example, in some instances the harmonics are dependent on such factors as the tool rotation speed, tool path parameters (e.g., feed rate, depth of cut, stepover, etc.), the type of material being milled (e.g., ceramic, composite, zirconia, gold, etc.), tool type (e.g., cutter, grinder), tool shapes (e.g., profile, number of cutting flutes for cutters, grit size of diamonds for grinders, etc.) and/or other factors. Accordingly, monitoring the vibrations associated with rotation of the milling tool comprises identifying a status of the milling machine at the time the vibrations were detected and comparing the vibrations to a set of threshold harmonics associated with the status of the milling machine.

Upon detecting harmonics indicative of a tool break, the method 200 continues at step 206 where the tool break is verified. In some instances, the tool break is verified using an optical sensor. In other instances, the tool break is verified using a camera. In general, the tool break is verified by comparing the current dimensions of the tool with the original, known dimensions of the tool. If the dimensions of the tool remain unchanged or within an acceptable range of the original dimensions, then the tool is not verified as being broken. Upon verifying that the tool is broken, the method 200 continues at step 208 where the broken tool is replaced with a replacement tool. In some instances, the broken tool is replaced automatically by a tool changer of the milling machine. In other instances, the milling machine sounds an alarm (visually, audible, or other human intelligible signal) that notifies a user that the tool needs to be replaced. In some instances, the alarm is sounded when no suitable replacement tool is available in the milling machine for the automatic tool changer to replace the broken tool. Accordingly, in some instances the tool replacement is performed at least partially by manual action of a user.

After replacement of the broken tool at step 208, the method 200 continues at step 210 where the milling process is resumed. In that regard, the milling process resumes at a time point earlier than the detection of the break in some instances. In some instances, the milling process resumes at a point in the milling process approximately 10 seconds prior to the point in the milling process when the break was detected. In other instances, the milling process resumes at a point in the milling process closer or further away in time to the point where the break was detected.

After the milling process has resumed at step 210, the method 200 continues again at step 204 with the monitoring of vibrations for harmonics indicative of tool breakage. In some instances, the monitoring is delayed until the milling process at least reaches the point in the milling process when the break was detected. For example, if the milling process resumes at a point 10 seconds prior to the break detection point, then monitoring of the vibrations is delayed for at least 10 seconds. Delaying the monitoring prevents a false positive of tool breakage immediately following the resumption of the milling process. In some instances, the delay goes beyond the point where the break detection occurred. The milling process continues with monitoring of the vibrations and replacement of broken tools as necessary until the milling process is completed at step 212.

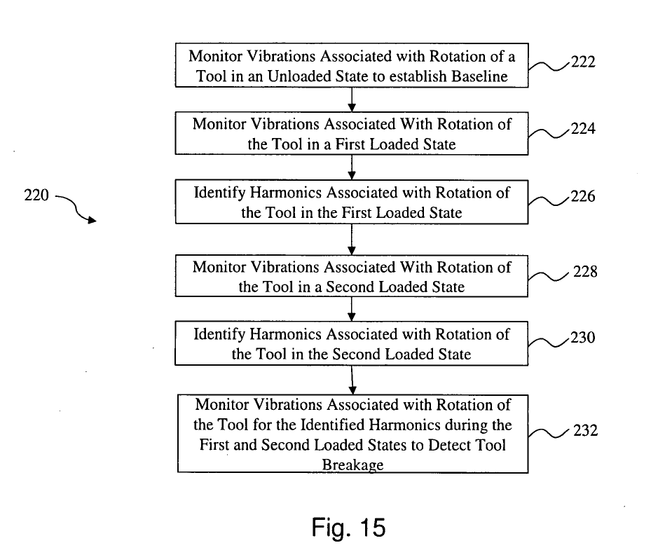

Referring now to FIG. 15, shown therein is a flowchart illustrating a method 220 of monitoring for tool breakage during a milling process having a plurality of tool loading states, according to one aspect of the present disclosure. The method 220 begins at step 222 where vibrations associated with rotation of a milling tool in an unloaded state are monitored to establish a baseline. In that regard, in some instances the milling tool is considered to be rotating in an unloaded state when it is freely spinning and not engaged with a milling block. In other words, the only resistance to the tool is caused by the milling system itself and not friction or resistance caused by engaging the tool with a block or other work piece. In some instances, the vibrations are monitored for a plurality of rotation speeds. Generally, the rotation speeds monitored are one or more of the rotation speeds that will be used in the milling process.

The method 220 continues at step 224 where vibrations associated with rotation of the milling tool in a first loaded state are monitored. In that regard, in some instances the milling tool is considered to be rotating in a loaded state when it is subjected to external resistance or friction, such as that caused by engaging a milling block. In other words, the tool is loaded if it is subjected to a load outside of the inherent loads present in the milling system itself. Similar to the unloaded state, in some instances, the vibrations are monitored for a plurality of rotation speeds. Generally, the rotation speeds monitored are those that will be used in the milling process. Further, in some instances, the tool is subjected to different types of loading during the milling process. For example, the loading is dependent on such factors as the tool rotation speed, tool path parameters (e.g., feed rate, depth of cut, stepover, etc.), the type of material being milled (e.g., ceramic, composite, zirconia, gold, etc.), tool type (e.g., cutter, grinder), tool shapes (e.g., profile, number of cutting flutes for cutters, grit size of diamonds for grinders, etc.) and/or other factors. Accordingly, in some instances the first loaded state of the tool includes one or more of these variables.

The method 220 continues at step 226 where the harmonics associated with rotation of the tool in the first loaded state are identified. Specifically, in some instances the harmonics having a sufficient amplitude difference between the unloaded state and the loaded state are identified as harmonics associated with rotation of the tool in the first loaded state. In that regard, the amount of amplitude difference that is considered to be sufficient is dependent on such factors as the noise in the system, the sensitivity and/or accuracy of the accelerometer, the available processing power of the processing system, the amount of available memory, and/or other factors.

The method 220 continues at step 228 where vibrations associated with rotation of the milling tool in a second loaded state are monitored. Similar to the first loaded state, in some instances the second loaded state of the tool includes one or more of these variables associated with the different types of loading present in the milling process. The method 220 continues at step 230 where the harmonics associated with rotation of the tool in the second loaded state are identified. Specifically, in some instances the harmonics having a sufficient amplitude difference between the unloaded state are identified as harmonics associated with rotation of the tool in the second loaded state.

Finally, the method 220 continues at step 232 where vibrations associated with rotation of the tool are monitored for the harmonics identified at steps 226 and 230 to detect tool breakage. For example, in some instances the harmonics associated with the rotation of the tool in the first loaded state are monitored when the tool is supposed to be in the first loaded state in accordance with the planned milling pattern and the harmonics associated with the rotation of the tool in the second loaded state are monitored when the tool is supposed to be in the second loaded state. In some instances, the accelerometer monitors the vibrations for the harmonics associated with both loaded states when the tool is to be milling in any loaded state. In some instances, the accelerometer constantly monitors the vibrations of the system during the milling process, but the processing system only analyzes those vibrations that occur during the time periods when loading of the tool is expected (e.g., during times of cutting and/or grinding of the block). In some instances, the processing system analyzes the vibrations only when the tool is expected to be in the first or second loaded states. In that regard, the first and second loaded states have the highest probability of tool breakage in some instances. For example, in some embodiments the first and second loaded states have the largest amount of load and/or friction placed on the tool. In other instances, the first and second loaded states are two identifiable, but not necessarily high-load states of the tool. Generally, if the amplitude of one or more of the identified harmonics varies from the established threshold for the corresponding state of the tool, then it is an indication of tool breakage.

In some instances the vibrations are monitored intermittently for tool breakage. In that regard, the rate of data sampling is chosen such that a break of the tool is identified within 5 seconds or less after the break occurs. In some instances, the rate of data sampling is selected to be a multiple of the frequency of tool rotation in order to minimize effects of spectral leakage. In some instances, the data sets are collected and analyzed between approximately 4 and 10 times per second, or approximately once every 100 to 300 milliseconds. In other instances, the data is analyzed between approximately 1 and 100 times per second, or once every 1000 to 10 milliseconds. In one particular embodiment, the data sets are collected and analyzed approximately every 200 milliseconds. In some instances, the exact timing of the data collection is checked against the stored toolpath data for the milling process in order to determine the corresponding expected state of the tool (e.g., unloaded, first loaded state, second loaded, state, etc.) of the milling process at the time of data collection.

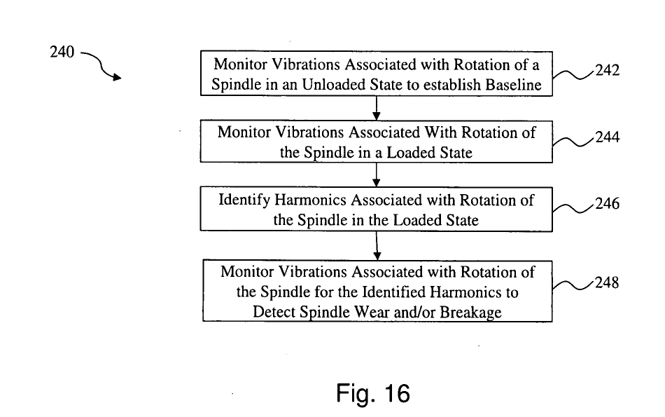

Referring now to FIG. 16, shown therein is a flowchart illustrating a method 240 of monitoring for spindle wear and/or breakage, according to one aspect of the present disclosure. The method 240 begins at step 242 where vibrations associated with rotation of a spindle in an unloaded state are monitored to establish a baseline. In that regard, in some instances the spindle is considered to be rotating in an unloaded state when it is freely spinning and any tools extending from the spindle are not engaged with a milling block. In other words, the only resistance to the spindle is caused by the milling system itself and not friction or resistance caused by engaging the tool with a block or other work piece. In some instances, the vibrations are monitored for a plurality of rotation speeds. Generally, the rotation speeds considered are those that will be used in the milling process. However, in some instances rotation speeds other than those utilized in the milling process are utilized to establish a baseline.

The method 240 continues at step 244 where vibrations associated with rotation of the spindle in a loaded state are monitored. In that regard, in some instances the spindle is considered to be rotating in a loaded state when it is subjected to external resistance or friction, such as that caused by a tool extending from the spindle engaging a milling block. In other words, the spindle is loaded if it is subjected to a load outside of the inherent loads present in the milling system itself. Similar to the unloaded state, in some instances, the vibrations are monitored for a plurality of rotation speeds. Generally, the rotation speeds considered are those that will be used in the milling process. Further, in some instances, the spindle is subjected to different types of loading during the milling process. For example, the loading is dependent on such factors as the spindle rotation speed, tool path parameters (e.g., feed rate, depth of cut, stepover, etc.), the type of material being milled (e.g., ceramic, composite, zirconia, gold, etc.), tool type (e.g., cutter, grinder), tool shapes (e.g., profile, number of cutting flutes for cutters, grit size of diamonds for grinders, etc.) and/or other factors. Accordingly, in some instances the vibrations are monitored for a plurality of loading situations based on one or more of these variables.

The method 240 continues at step 246 where the harmonics associated with rotation of the spindle in the loaded state are identified. Specifically, in some instances the harmonics having a sufficient amplitude difference between the unloaded and loaded states are identified as harmonics associated with rotation of the spindle in the loaded state. In that regard, the amount of amplitude difference that is considered to be sufficient is dependent on such factors as the noise in the system, the sensitivity and/or accuracy of the accelerometer, the available processing power of the processing system, the amount of available memory, and/or other factors. Finally, the method 240 continues at step 248 where vibrations associated with rotation of the spindle are monitored for the harmonics identified at step 246 to detect spindle wear and/or breakage. In some instances, the monitoring is performed intermittently as discussed above with respect to other embodiments.

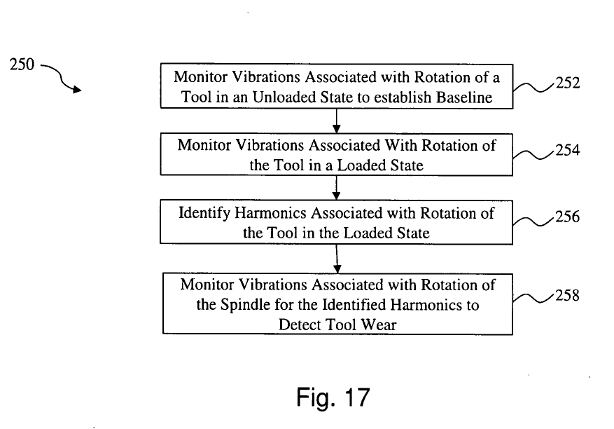

Referring now to FIG. 17, shown therein is a flowchart illustrating a method 250 of monitoring for tool wear, according to one aspect of the present disclosure. The method 250 begins at step 252 where vibrations associated with rotation of a milling tool in an unloaded state are monitored to establish a baseline. The method 250 continues at step 254 where vibrations associated with rotation of the milling tool in a loaded state are monitored. In that regard, in some instances the vibrations are monitored for one or more of a plurality of loading situations based on one or more loading variables. The method 250 continues at step 256 where the harmonics associated with rotation of the tool in the loaded state are identified. Specifically, in some instances the harmonics having a sufficient amplitude difference between the unloaded and loaded states are identified as harmonics associated with rotation of the tool in the loaded state. The method 250 continues at step 258 where vibrations associated with rotation of the tool are monitored for the harmonics identified at step 256 to detect tool wear. In that regard, whereas with tool breakage the harmonics decrease to a level approximating the unloaded state in some instances, the harmonics associated with tool wear decrease to a level between the loaded and unloaded states. In some instances, a comparison of the harmonics over the life of a tool can indicate a trend of wearing and/or the amount of wearing.

In the case where a tool has become worn, the tool becomes less efficient in its grinding or cutting operation. This loss of efficiency is manifested as a decrease in the actual rotation speed of the tool in some instances. In that regard, the rotation speed of the tool becomes lower than the desired or commanded rotation speed due to the decrease in cutting efficiency. In other instances, the tool speed does not decrease but the power required to spin to the tool at the desired speed is increased because of the less efficient cutting or grinding state of the worn tool. Further, in some instances there are additional detectors in the milling machine, for example strain gauges, that are used to measure the mechanical loading of the tool on one or more axes. Accordingly, in some instances, the actual rotation speed of the tool, the instantaneous power consumed by the spindle, and/or the mechanical loading of the tool are monitored as indicators of tool wear. In some instances, these factors are monitored in addition to the harmonics to detect tool wear. In other instances, these factors are utilized to select which harmonics should be monitored for signs of increased tool wear. In that regard, the tool rotation speed, power consumption, and mechanical loading are factors associated with the loading of the tool. Accordingly, these factors are considered as part of a loading state of the tool, in some instances, and are utilized to select the harmonics that should be monitored for detecting tool wear.

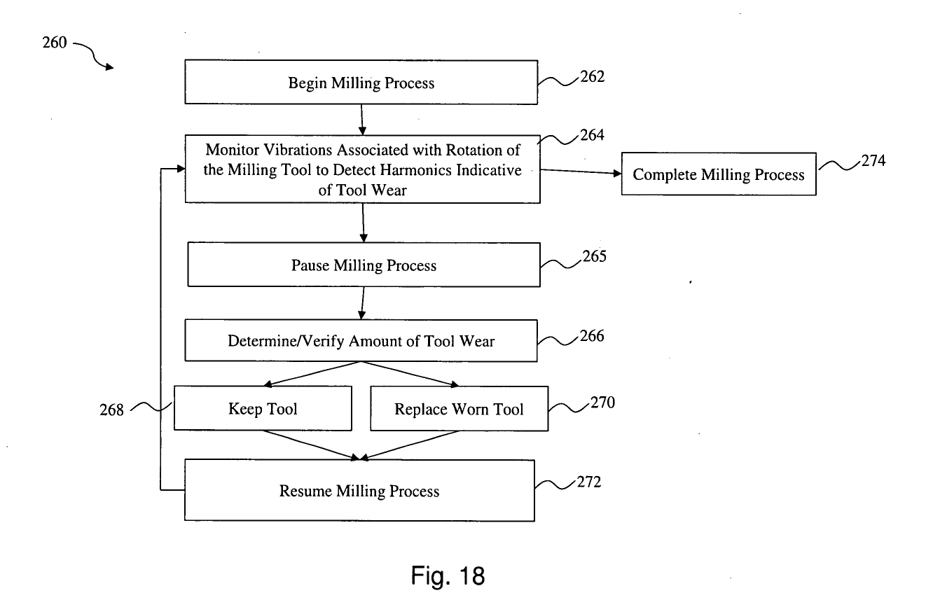

Referring now to FIG. 18, shown therein is a flowchart illustrating a method 260 of monitoring for tool wear during a milling process, according to one aspect of the present disclosure. The method 260 begins at step 262 where a milling process begins. In some instances, the milling process is the milling of a dental prosthetic from a block of suitable dental material. The method 260 continues at step 264 where vibrations associated with rotation of a milling tool are monitored to detect harmonics indicative of tool wear. In some instances, the harmonics indicative of tool wear are determined as set forth in method 250 above. In that regard, in some instances step 264 includes identifying the harmonics associated with a loaded tool by comparing the spectrum of a loaded tool to an unloaded tool.

Upon detecting harmonics indicative of tool wear, the method 260 continues at step 265 where the milling process is paused. That is, the cutting and grinding of the block is temporarily stopped in order to address the tool wear detection. The method 260 continues at step 266 where the amount of tool wear is determined and/or verified. In some instances, the tool wear is determined or verified using an optical sensor. In other instances, the tool wear is verified using a camera. In general, the tool wear is verified by comparing the current dimensions of the tool with the original, known dimensions of the tool. If the dimensions of the tool remain unchanged or within an acceptable range of the original dimensions, then the tool is not verified as being too worn for use and the tool is kept at step 268. However, upon verifying that the tool is too worn down for suitable milling use, the method 260 continues at step 270 where the worn tool is replaced with a replacement tool. In some instances, the worn tool is replaced automatically by a tool changer of the milling machine. In other instances, the milling machine sounds an alarm (visually, audible, or other human intelligible signal) that notifies a user that the tool needs to be replaced. In some instances, the alarm is sounded when no suitable replacement tool is available in the milling machine for the automatic tool changer to replace the broken tool. Accordingly, in some instances the tool replacement is performed at least partially by manual action of a user.

After the tool has either been kept at step 268 or replaced at step 270, the method 260 continues at step 272 where the milling process is resumed. In that regard, in some instances the milling process resumes at a point in the milling process earlier than the point where the milling process was paused upon detection of the wear. In some instances, the milling process resumes at a point in the milling process approximately 10 seconds prior to the pause point. In other instances, the milling process resumes at a point in the milling process closer or further away in time to the pause point.

After the milling process has resumed at step 272, the method 260 continues again at step 264 with the monitoring of vibrations for harmonics indicative of tool wear during the milling process. In some instances, the monitoring is delayed until the milling process at least reaches the point in the milling process when the milling process was paused. For example, if the milling process resumes at a point 10 seconds prior to the pause point, then monitoring of the vibrations is delayed for at least 10 seconds. Delaying the monitoring prevents a false positive of tool wear immediately following the resumption of the milling process. In some instances, the delay goes beyond the paused point where the break detection occurred. The milling process continues with monitoring of the vibrations and replacement of broken tools as necessary until the milling process is completed at step 274.

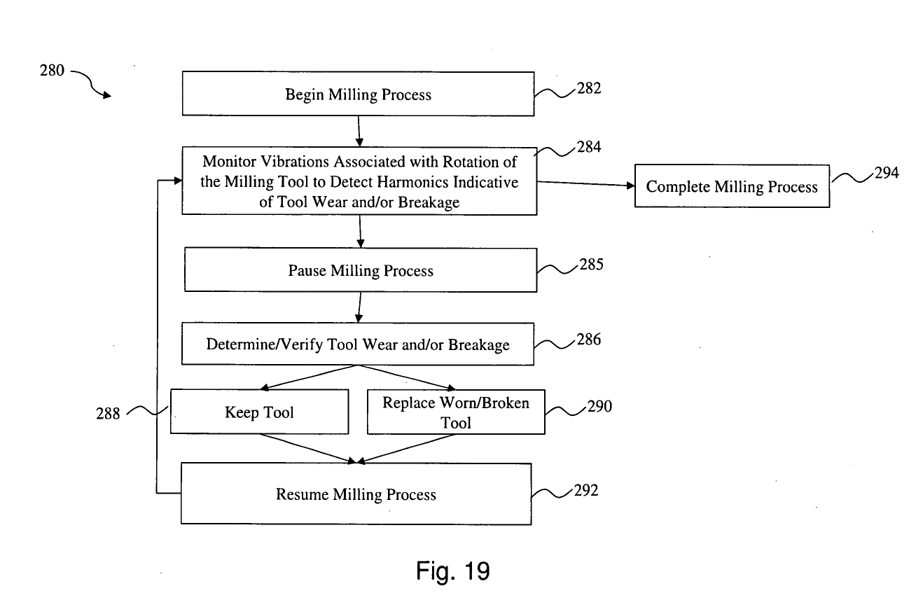

Referring now to FIG. 19, shown therein is a flowchart illustrating a method 280 of monitoring for tool wear and/or breakage during a milling process according to one aspect of the present disclosure. Generally, the method 280 is similar in some aspects to the methods 200 and 260 described above. In that regard, the method 280 monitors both tool wear and tool breakage during a milling process. The method 280 begins at step 282 where a milling process begins. In some instances, the milling process is the milling of a dental prosthetic from a block of suitable dental material. The method 280 continues at step 284 where vibrations associated with rotation of a milling tool are monitored to detect harmonics indicative of tool wear and/or tool breakage. Upon detecting harmonics indicative of tool wear and/or tool breakage, the method 280 continues at step 285 where the milling process is paused. That is, the cutting and grinding of the block is temporarily stopped in order to address the tool wear and/or tool breakage detection. The method 280 continues at step 286 where the amount of tool wear is determined and/or verified and/or the tool breakage is verified. In some instances, the tool wear and/or breakage is determined or verified using an optical sensor. In other instances, the tool wear and/or breakage is verified using a camera. In general, the tool wear and/or breakage is verified by comparing the current dimensions of the tool with the original, known dimensions of the tool. If the dimensions of the tool remain unchanged or within an acceptable range of the original dimensions, then the tool is considered acceptable and the tool is kept at step 288. However, upon verifying that the tool is too worn down or broken to be used, the method 280 continues at step 290 where the worn tool is replaced with a replacement tool. In some instances, the worn tool is replaced automatically by a tool changer of the milling machine. In other instances, the tool replacement is performed at least partially by manual action of a user.

After the tool has either been kept at step 288 or replaced at step 290, the method 280 continues at step 292 where the milling process is resumed. In that regard, in some instances the milling process resumes at a point in the milling process earlier than the point where the milling process was paused upon detection of the wear and/or breakage. After the milling process has resumed at step 292, the method 280 continues again at step 284 with the monitoring of vibrations for harmonics indicative of tool wear and/or breakage during the milling process. In some instances, the monitoring is delayed until the milling process at least reaches the point in the milling process when the milling process was paused. The milling process continues with monitoring of the vibrations and replacement of worn down and broken tools, as necessary, until the milling process is completed at step 294.

The present disclosure has been set forth with reference to specific exemplary embodiments and figures. It will, however, be evident that various modifications and changes may be made thereto without departing from the broader spirit and scope of the present disclosure. For example, the various components, features, or steps of the different embodiments described herein may be combined with the components, features, and steps of the other embodiments described herein. Accordingly, the specification and drawings of the present disclosure are to be regarded in an illustrative sense rather than a restrictive sense.

What is claimed is:

1. A dental milling system comprising:
a first milling tool for milling a dental prosthetic;
a first spindle operable to receive and fixedly engage the first milling tool, the first spindle further operable to rotate the first milling tool when the first milling tool is received by and fixedly engaged with the first spindle;
a first accelerometer positioned adjacent to the first spindle and operable to detect vibrations associated with rotation of the first milling tool; and
a processor in communication with the first accelerometer to receive data sets representative of the vibrations detected by the first accelerometer, the processor operable to process the data sets to identify changes in one or more harmonics of the detected vibrations indicative of a break of the first milling tool.

2. The system of claim 1, further comprising an automatic tool changer operable to replace the first milling tool with a second milling tool in the event the processor identifies a change in one or more of the harmonics indicative of a break of the first milling tool.

3. The system of claim 2, further comprising a sensor configured to detect a shape of the first milling tool to verify the break of the first milling tool in the event the processor identifies a change in one or more of the harmonics indicative of a break of the first milling tool.

4. The system of claim 3, wherein the sensor comprises an optical sensor.

5. The system of claim 1, wherein the processor is operable to process the data sets intermittently.

6. The system of claim 5, wherein the processor is operable to process the data sets between 4 and 10 times per second.

7. The system of claim 5, wherein each of the one or more harmonics has an amplitude threshold and wherein a data set having a detected amplitude less than the amplitude threshold is indicative of a break of the first milling tool.

8. The system of claim 7, wherein the processor is operable to send a tool change command to an automatic tool changer upon processing at least five consecutive data sets having a detected amplitude less than the amplitude threshold, the automatic tool changer operable to replace the first milling tool with a second milling tool.

9. The system of claim 1, further comprising:
a second milling tool for milling a dental prosthetic;
a second spindle operable to receive and fixedly engage the second milling tool, the second spindle further operable to rotate the second milling tool when the second milling tool is received by and fixedly engaged with the second spindle; and
a second accelerometer positioned adjacent to the second spindle and operable to detect vibrations associated with rotation of the second milling tool;
wherein the processor is in communication with the second accelerometer to receive data sets representative of the vibrations detected by the second accelerometer, and wherein the processor is operable to process the data sets to identify changes in one or more harmonics of the detected vibrations indicative of a break of the second milling tool.

10. The system of claim 1, wherein the processor is further operable to process the data sets to identify changes in one or more harmonics of the detected vibrations indicative of a wearing down of the first milling tool.

11. A method of detecting a tool break in a dental milling machine, comprising:
monitoring vibrations associated with rotation of a first milling tool in an unloaded state;
monitoring vibrations associated with rotation of the first milling tool in a first loaded state;
identifying one or more harmonics associated with rotation of the first milling tool in the first loaded state; and
monitoring vibrations associated with rotation of the first milling tool for the one or more identified first-loaded-state harmonics during a milling process to detect a break of the first milling tool.

12. The method of claim 11, wherein identifying the one or more harmonics comprises comparing an unloaded amplitude of the harmonic associated with rotation of the first milling tool in the unloaded state to a loaded amplitude of the harmonic associated with rotation of the first milling tool in the loaded state.

13. The method of claim 11, wherein the monitoring of the vibrations comprises:
detecting the vibrations with a first accelerometer during the milling process; and
processing data sets representative of the vibrations detected by the first accelerometer to identify changes in the one or more identified harmonics of the detected vibrations indicative of a break of the first milling tool.

14. The method of claim 13, wherein the data sets are processed intermittently.

15. The method of claim 14, wherein the data sets are processed between 4 and 10 times per second.

16. The method of claim 13, wherein each of the one or more identified harmonics has an amplitude threshold and wherein a data set having a detected amplitude less than the amplitude threshold is indicative of a break of the first milling tool.

17. The method of claim 11, further comprising detecting a shape of the first milling tool to verify a detected break of the first milling tool.

18. The method of claim 17, further comprising replacing the first milling tool with a second milling tool upon verification of the detected break.

19. The method of claim 11, further comprising
monitoring vibrations associated with rotation of the first milling tool in a second loaded state; and
identifying one or more harmonics associated with rotation of the first milling tool in the second loaded state;
wherein the monitoring of the vibrations further comprises monitoring the vibrations for the one or more identified second-loaded-state harmonics.

20. A method of milling a dental prosthetic, comprising:
detecting vibrations of a milling machine during a milling process with an accelerometer, the milling machine comprising a spindle for rotating a first tool engaged with the spindle; and
analyzing data sets representative of the detected vibrations for changes in amplitude of one or more harmonics of the first tool rotation indicative of tool breakage.

21. The method of claim 21, wherein upon detection of a change in amplitude indicative of tool breakage the method further comprises:
stopping the milling process;
replacing the first tool with a second tool; and
resuming the milling process.

22. The method of claim 21, wherein upon detection of a change in amplitude indicative of tool breakage the method further comprises verifying the tool breakage.

23. The method of claim 21, wherein replacing the first tool with a second tool is performed by an automatic tool changer of the milling machine.

24. The method of claim 21, wherein the milling process is resumed at a processing point prior to the processing point where the milling process was stopped.

25. The method of claim 24, wherein analyzing the data sets for changes in amplitude indicative of tool breakage resumes when the milling process reaches the processing point where the milling process was stopped.

26. A method of detecting tool wear in a dental milling machine, comprising:
detecting vibrations of a milling machine during a milling process with an accelerometer, the milling machine comprising a spindle for rotating a first tool engaged with the spindle; and
analyzing data sets representative of the detected vibrations for changes in amplitude of one or more harmonics of the first tool rotation indicative of tool wear.

27. The method of claim 26, further comprising:
detecting a rotation speed of the first tool;
comparing the detected rotation speed to an expected rotation speed, wherein the detected rotation speed being less than expected rotation speed is an indication of tool wear.

28. The method of claim 26, further comprising:
detecting a power consumption of the first spindle;
comparing the detected power consumption to an expected power consumption, wherein the detected power consumption being less than expected power consumption is an indication of tool wear.

29. The method of claim 26, wherein the one or more harmonics are at least partially determined by one or more of a detected rotation speed of the first tool, a detected power consumption of the first spindle, and a detected mechanical loading of the first tool.
